(19) United States
(12) Patent Application Publication
(10) Pub. No.: US 2010/0220006 A1
(43) Pub. Date: Sep. 2, 2010

(54) GLOBAL POSITIONING SYSTEMS BASED DISCIPLINED REFERENCE CLOCK

(76) Inventors: Amir Arab, Montreal (CA); Daniel Chiasson, Montreal (CA); Simon Beliveau, Verdun (CA); Eric Schmidt, Saint-Laurent (CA)

Correspondence Address: KAUTH , POMEROY , PECK & BAILEY ,LLP, 2875 MICHELLE DRIVE, SUITE 110, IRVINE, CA, 92606, US

(21) Appl. No.: 12/395,323

(22) Filed: Feb. 27, 2009

(51) Int. Cl. G01S 1/00

(52) U.S. Cl. 342/357.12

(57) ABSTRACT

A disciplined reference clock generating a frequency accurate clock signal based on a reference pulse generated by a global positioning system is provided. Clock circuitry and processes are also provided to ensure frequency locking and signal validity of the generated clock signal.

### BACKGROUND

The present invention relates to reference clocks, and in particular, to disciplined clocks for radio communication systems that use a GPS system as a timing reference.

Off the shelf GPS disciplined clocks exist but are very expensive. Most of them use, in addition to a GPS receiver, an OCVCXO (oven compensated voltage controlled oscillator) and non volatile memory (NVRAM). When the GPS disciplined clock receives a valid GPS 1 pulse per second (PPS) signal, it uses it to calibrate (discipline) the on-board OCVCXO, and the calibration values are updated in NVRAM. If the 1 PPS signal is lost for any reason, the clock output will be able to remain within specification for 2 reasons: the OCVCXO is kept at a constant high temperature—that insures virtually no drift, and the calibration data stored in NVRAM is used in an open loop fashion to maintain proper OCVCXO pull. Such a disciplined clock uses a dedicated microcontroller and associated circuits.

It is however difficult for the disciplined clock circuitry to assess a “locked” condition given the precision required. The control loop can be forever unlocked if the initial frequency offset is too far from the target (e.g., ±0.1 ppm or as required by the application). Maintaining accuracy of the output clock signal given the enormous jitter in the 1 PPS pulse can also be difficult. Also, accounting for all potential events, sequence of events, and time-outs and handling them appropriately so the disciplined clock can recover are further aspects of the problem that are difficult to overcome. A few such examples include quickly recovering (re-acquire lock) from a temporary loss of GPS signal due to antenna replacement or other installation mishaps, re-acquiring a “lock” as quickly as possible, even when the host controller gets a full firmware upgrade, or even when the disciplined clock FPGA gets reconfigured.

Accordingly, there is a need to provide a disciplined reference clock for radio communication systems while overcoming the obstacles and shortcomings previously noted and/or recognized in the art.

### SUMMARY

Generally, the disciplined clock acts as an enhanced phase locked loop (PLL) that produces a precise 10 MHz signal using the 1 PPS pulse from a global positioning system (GPS) receiver or module as an absolute timing reference. The resulting precision of the 10 MHz output, when locked, measured over 1 second is ±0.1 ppm.

In one embodiment, a global positioning system based disciplined reference clock circuitry comprises a global positioning system receiver generating a reference pulse, a digital to analog converter supplying a control voltage, and an oscillator locked to the reference pulse from global positioning module and controlled via the control voltage of the digital to analog converter to generate a clock signal.

In another embodiment, a method of generating a disciplined clock from a global positioning system based disciplined reference clock circuitry is provided. The method comprises receiving a reference pulse from a global positioning system receiver, generating a clock signal based on the received reference pulse, estimating an instantaneous frequency offset between the reference pulse and the clock signal, and applying a control voltage to an oscillator based on the estimated instantaneous frequency offset compared an absolute value of the frequency offset to adjust a frequency of the clock signal.

The above-mentioned and other features of this invention and the manner of obtaining and using them will become more apparent, and will be best understood, by reference to the following description, taken in conjunction with the accompanying drawings. The drawings depict only typical embodiments of the invention and do not therefore limit its scope.

### BRIEF DESCRIPTION OF THE DRAWINGS

FIG. 1 is a block diagram illustrating disciplined clock circuitry that includes a GPS receiver in accordance with various embodiments of the invention.

FIG. 2 is a flowchart illustrating an overview of a disciplined clock control process in accordance with various embodiments of the invention.

FIG. 3 is a flowchart illustrating a detailed portion (block 201 of FIG. 6B) of a disciplined clock control process in accordance with various embodiments of the invention.

FIG. 4 is a flowchart illustrating a detailed portion (block 56 of FIG. 3) of a disciplined clock control process in accordance with various embodiments of the invention.

FIG. 5 is conceptual block diagram of a disciplined clock control process in accordance with various embodiments of the invention.

FIGS. 6A-C are flowcharts illustrating a disciplined clock control process in accordance with various embodiments of the invention.

### DETAILED DESCRIPTION

Disciplined clock circuits in accordance with embodiments of the invention utilize a microprocessor to function as an enhanced phase locked loop to condition a local oscillator using a 1 PPS signal generated as an output by a GPS receiver. In a number of embodiments, the disciplined clock circuitry is provided as part of a base-station controller (BSC) for a communication system and the circuitry uses idle capacity on the microcontroller of the BSC to implement the enhanced phase locked loop. In several embodiments, the enhanced phase locked loop accommodates jitter that may be present on the 1 PPS signal. In many embodiments, the enhanced phase lock loop utilizes a phase comparator to determine the stability of the frequency of the output clock signal and an instantaneous frequency offset to minimize lock acquisition times.

Generally, the GPS disciplined clock circuitry provided is more modest and less expensive than traditional disciplined clock systems. The disciplined clock circuitry is an “add-on” module in the form of a simple unpackaged electronic card. In one embodiment, the disciplined clock circuitry is piggy-backed on the main controller board of a base-station controller (BSC). The base station controller board contains a CPU that has excess computing power. The disciplined clock circuitry taps into that available capacity instead of using or requiring its own dedicated micro-controller or processor. In one embodiment, the real-time portion of the control-loop as well as specific logic utilized to access particular circuits on the GPS disciplined clock assembly are implemented in a hardware description language, e.g., VHDL, in a small field programmable gate array (FPGA) Located on the GPS disciplined clock module. The FPGA is fully configured by the BSC with its configuration file located in the BSC flash file system. Low cost is thus achieved by tailoring the performance to the level needed, for example, using ±0.1 ppm accuracy whereas most traditional GPS based 10 MHz references are more precise, and using the computing power and memory system of a host CPU (e.g., the BSC).

As noted above, the disciplined clock circuitry generally acts as an enhanced phase locked loop. The output of the circuitry is a 10 MHz signal and the input is a 1 PPS pulse from a GPS receiver. A disciplined clock control loop locks the 10 MHz output signal in phase with the 1 PPS average rising edge position. The precision of this lock guarantees accuracy to within ±0.1 ppm. In general, the control loop is a proportional-integral (PI) control loop and is described in greater detail below. The phase comparator in one embodiment utilizes a digital counter in a FPGA.

The disciplined clock circuitry can be relatively slow to lock, a result of the 1 PPS stimulus being a 1 Hz signal. At power-up, the actual state of the 10 MHz output depends on the GPS receiver producing a valid 1 PPS, and the measured 10 MHz signal phase error. The combined delays constitute the locking time that can be as large as 800 seconds (13 min 20 sec).

The quality of the 10 MHz signal however is crucial to the base-station operation. The base station contains transmitters and receivers that need an accurate frequency reference in order to tune-in to the allocated communication channels precisely. Until the 10 MHz reference is locked, the base station cannot operate as per regulations or specifications. Base stations are on continuously and maintenance must be as quick as possible with minimal down time.

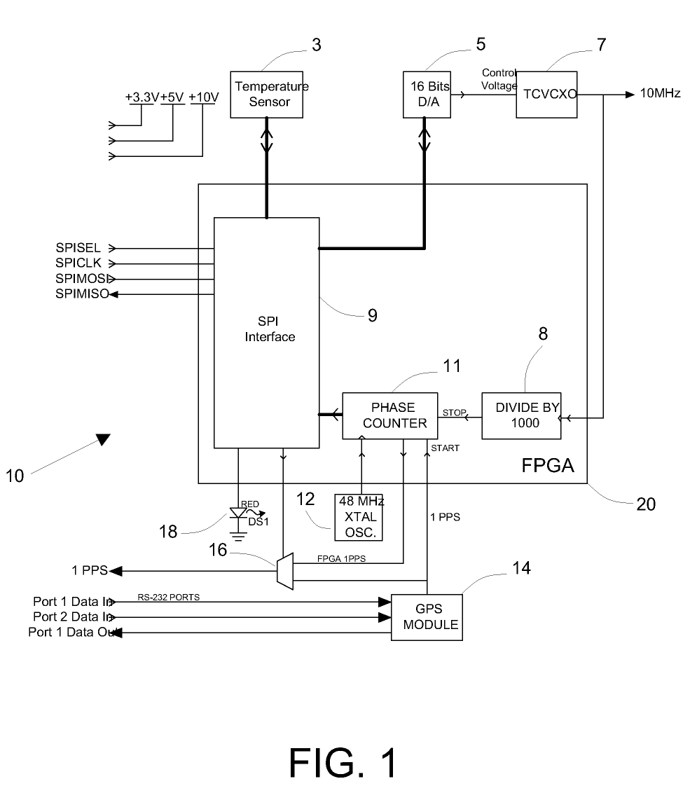

In FIG.1, one embodiment of such a 10 MHz disciplined clock circuitry 10 is shown that is a frequency accurate 10 MHz generator. The 10 MHz source generated is the output of a Temperature compensated Voltage controlled Crystal Oscillator 7 (TCVCXO) that is locked to an accurate 1 pulse per second (PPS) signal that is supplied from an output of a global positioning system (GPS) module 14.

The TCVCXO 7 has a ±5 parts per million (PPM) minimum pulling range to compensate for aging and temperature variation with a specified stability of ±1 PPM over a −40 to +85° C. temperature range. The TCVCXO frequency is controlled via a DC control voltage applied to its control voltage input from a 16 bit digital to analog converter (DAC) 5.

A 12 bit temperature sensor 3 coupled to the SPI interface 9 is located near the TCVCXO 7. The temperature sensor 3 is used to record the applied TCVCXO control voltage compensation relative to temperature.

The field programmable gate array (FPGA) 20 provides a slave SPI interface 9 to the base station controller (BSC) main processor and provides a control interface to the D/A converter (DAC) 5 and the temperature sensor 3. In one embodiment, the FPGA 20 is an Altera Cyclone II, 256 balls (Fine line Ball Gate Array) with 4608 logic elements and 158 available input/outputs. The FPGA also includes a divider 8 (divide by 1000) and a phase counter 11 used to measure the phase drift between the 10 MHz generated by the TCVCXO 7 and the 1 PPS signal from the GPS module 14. The phase counter or comparator 11 starts counting from the rising edge of the 1 PPS signal and stops counting at the rising edge of a 10 KHz signal, derived from the 10 MHz output.

The phase comparator measures the delay between the reference signal (1 PPS) and the feedback signal (10 MHz divided by 1000). This is equivalent to measuring the phase offset with respect to 1 PPS of the 10 MHz output signal over 1000 cycles of this signal. The rate at which the comparator changes is an indication of the 10 MHz frequency offset. A constant value implies that the two signals are phase locked and frequency locked. The phase counter is also supplied a 48 MHz clock source coming from a crystal oscillator 12 asynchronous to both of the signals measured. In this illustrated embodiment, a FPGA 1 PPS signal also outputs from the phase counter to a multiplexer 16 also receives the 1 PPS output from the GPS module. The FPGA 1 PPS signal is a modified version (polarity change and/or pulse width change) of the GPS 1 PPS signal that can be optionally supplied to the host controller (at the 1 PPS output of 16) instead of the GPS 1 PPS signal. This is provided to simplify the electrical interface between the GPS 1 PPS source and the host processor interrupt line.

The rising edge on the 1 PPS output of the GPS module 14 can have as much as ±1 μsec jitter with respect to the rising edge of the true GPS second. The jitter can cause significant variations in the phase count value and thus is filtered out before it is used as a reference input to the control loop that locks the TCVCXO 7. The BSC main processor includes a 1^{st} order infinite impulse response (IIR) low pass filter to filter the 1 PPS output from the GPS module. In particular upon detection of the 1 PPS signal (about every second), the BSC processor reads the phase comparator value, filters it and applies the appropriate command to the TCVCXO control voltage through the DAC to achieve or maintain phase lock. The processor in one embodiment utilizes a Proportional-Integral (PI) controller strategy.

The BSC processor loads the FPGA 20 of the 10 MHz disciplined clock circuitry 10 utilizing a configuration data file that is a compressed “raw binary file” (.rbf). An integrated watchdog circuit controls the sanity of the FPGA operational process. After the FPGA 20 is successfully loaded it drives the watchdog input. If the FPGA fails to toggle this line, the watchdog circuit will force the FPGA into a reconfiguration mode and the BSC CPU will then reload the configuration data into the FPGA. A visual indicator 18 (e.g., a red LED) is used to indicate the board functional and operational status.

The 10 MHz Disciplined Clock control interface is a custom designed SPI interface 9. The 4 SPI lines, i.e. SPISEL, SPICLK, SPIMOSI and SPIMISO, are physical interconnections to the BSC processor through which the processor controls the disciplined clock circuitry 10.

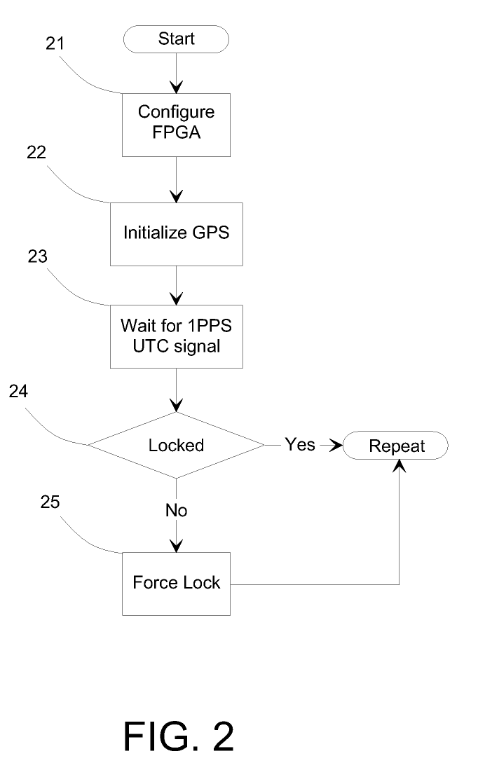

Referring now to FIG. 2, an overview of the disciplined clock control process is shown. The FPGA of the disciplined clock circuitry is first configured as needed (21) and the GPS module initialized (22). The process waits until a 1 PPS universal time coordinated (UTC) signal as opposed to a real time clock (RTC) signal is produced from the GPS module (23). A 1 PPS UTC signal indicates that the GPS module is deriving time directly from the GPS satellites. A 1 PPS RTC signal indicates that the GPS module is using an internal real time clock as a reference, which is not nearly as accurate and stable.

Upon receiving the 1 PPS UTC signal, the disciplined clock circuitry verifies if the clock circuitry is in a locked condition (24). A locked condition indicates that an accurate 10 MHz clock signal is being generated by the disciplined clock circuitry. If an unlock condition is detected, the process forces a lock (25). The process, unless terminated, periodically continues to assess the lock condition of the clock circuitry and forces a lock as needed. The clock circuitry and the associated control process is described in greater detail below and also accounts for other states or conditions to ensure that an accurate 10 MHz clock signal is generated.

### Assessing a Lock Condition

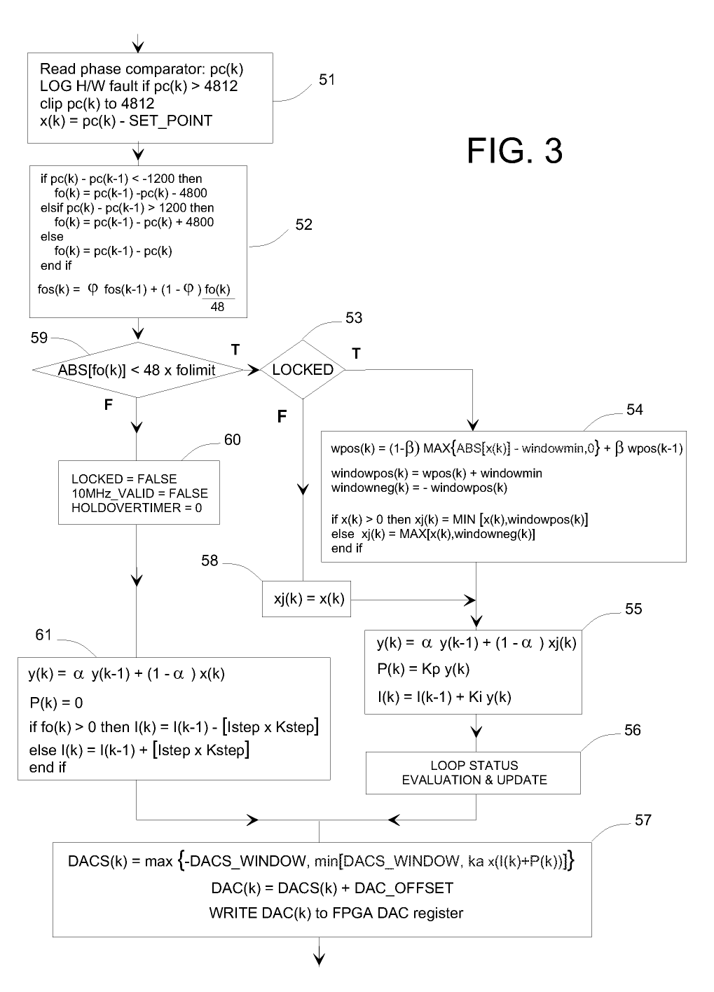

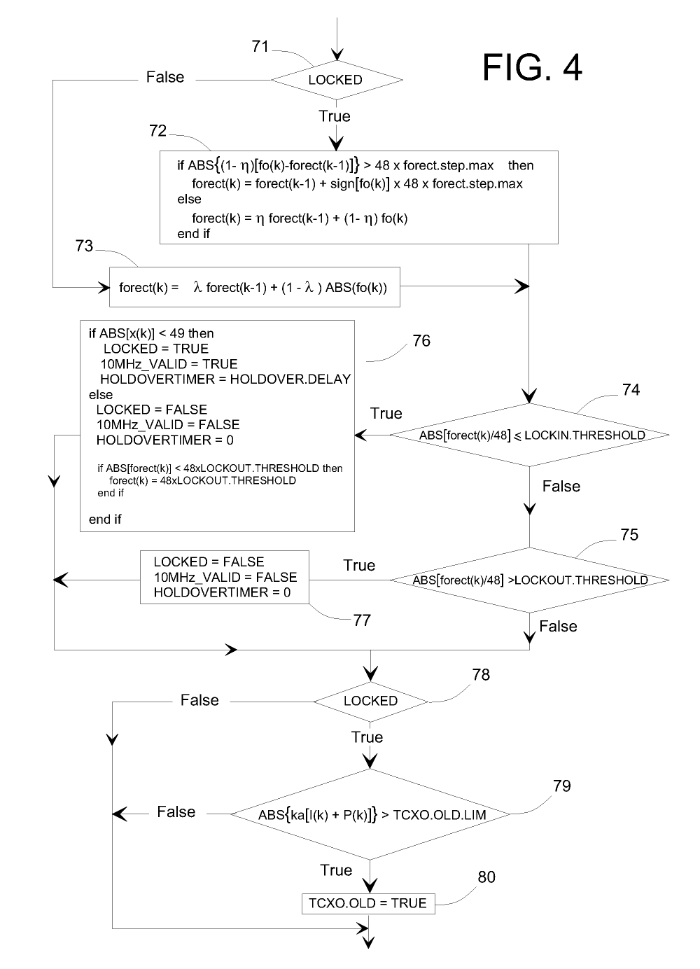

Referring now also to FIGS. 3-5, the clock control system is configured to estimate the instantaneous frequency offset, rectify it, and filter it (low pass IIR 52). When the rectified and filtered frequency offset is below a set limit, e.g., a LOCKIN.THRESHOLD limit, then the clock circuitry is declared locked. Using the absolute value of the frequency offset allows the comparison with a threshold, and filtering attenuates the “small scale” aberrations due mainly to jitter in the 1 PPS pulse rising edge position. It should be noted that the clock control system as described here includes the disciplined clock circuitry, the FPGA and the BSC processor.

### Assessing an Unlock Condition

An unlocked condition is detected in two ways. First, the clock control system estimates the instantaneous frequency offset, if the absolute value of that offset is greater than a coarse limit, an unlocked condition is detected. The coarse analysis is thus used for a quick detection of an unlocked condition. Secondly, the clock control system estimates the instantaneous frequency offset, rectifies it, and filters it (low pass IIR). When the rectified and filtered frequency offset is above the LOCKOUT.THRESHOLD limit, then an unlocked condition is detected. It should be noted that the criteria for detecting an unlocked condition and for assessing a locked condition provide a hysteresis that avoids a locked-unlocked oscillation.

### Accelerating and Insuring a Lock Condition

When an unlock condition is detected by the coarse analysis, instead of executing the standard PI controller (which may lead to infinite lock times) the clock control system directly acts upon the controller integrator 32. If the frequency offset is positive, the integrator is reduced by a fixed amount, if the frequency offset is negative the integrator is increase by a fixed amount. This quickly brings the frequency offset within locking range, where the PI controller can bring it to a locked condition.

### Accounting for Jitter in the 1 PPS Pulse

When the loop is locked, a violent time jitter episode in the 1 PPS rising edge can force the loop back to an unlocked condition. The jitter, however large, is a documented random effect that is to be eliminated when the loop is locked. As such, the clock control system of the disciplined clock implements window clipping 33 of the phase error.

First, the phase counter is read, then the phase error with respect to a target value is calculated, this is x(k). When the loop is locked, the average value of x(k) is 0, and its instantaneous value hovers around 0, sometimes negative, sometimes positive. The target value x(k) is then clipped using a window centered at 0. The window has its symmetrical limits (upper and lower) set so that small jitter values do not cause clipping, but large values do. As such, the window reduces the effect of a large jitter.

A side effect of window clipping is that it can prevent the loop from correctly tracking the 1 PPS rising edge position. The side effect is eliminated by making the window width adaptive. Each time that there is clipping, the limits symmetrically widen-up, and each time that there is no clipping, the limits symmetrically narrow-down back to the initial limits. The process used is that of a low pass IIR filter:

wpos(k)=(1−β)×max {abs [x(k)]−windowmin,0}+β×wpos(k−1)

where:
wpos(k) is the current variation of the window upper limit
wpos(k−1) is the last variation of the window upper limit
windowmin is the value of the window initial upper limit
β is the IIR feedback ratio (β<1).
   The window upper limit is: windowpos(k)=wpos(k)+windowmin. The window lower limit is: Windowneg(k)=−windowpos(k).
   Recovering from a Temporary Loss of the GPS Signal Due

In order to take into account the loss of the 1 PPS pulse from the GPS module, the discipline clock qualifies the 10 MHz reference by having two conditions (Locked/unLocked and valid/not valid). The locked/unlocked qualifies the state of the control loop, but valid/not valid qualifies the 10 MHz output accuracy. In the absence of a 1 PPS pulse, the 10 MHz signal can be valid and usable by a base-station even if the control loop is effectively stopped.

The TXVCXO in one embodiment has a very small drift for a given control voltage and temperature. If the loop had previously been locked (and valid), then a loss of 1 PPS will force the loop into unlocked but keep the 10 MHz as valid as long as the temperature remains constant (±allowed variation).

The FPGA also contains a timer, which decrements at a rate of 1 Hz (not dependent on the 1 PPS) and can be used as a hold-over timer. It times-out the “valid” property of the 10 MHz output. When the timer reaches 0, then the 10 MHz is considered having drifted too much and is declared invalid.

The hold-over initialized time-out is relatively large (at least 1 hour), time enough for the replacement of a GPS antenna, so the challenge for the control loop is to restart the PI process gracefully, without causing the loop to unlock. When the control loop is stopped, the instantaneous phase of the 10 MHz output signal drifts very slowly with respect to the 1 PPS rising edge. This drift can end-up being quite large near the end of the hold-over period, and if the loop is restarted at that moment, the phase error will be very large and will cause the loop to unlock. This wilt result in a locking time similar to a power-up condition. To eliminate this, the phase counter accumulated drift is eliminated before restarting the PI control loop. The FPGA contains a special structure especially designed for that purpose. The controller instructs the FPGA to reposition the measurement point on the 10 MHz reference output phase so that it corresponds to the 1 PPS rising edge position. When that is done, the control loop can restart smoothly, and a lock can be declared locked within seconds.

### Firmware Upgrades and FPGA Upgrades

By keeping the disciplined clock state (all state variables) in the FPGA internal memory, firmware and FPGA upgrades are allowed. The disciplined clock circuit is designed to run using the latest applied settings until the settings are updated. During a firmware upgrade, the control process is first terminated without resetting the states in the disciplined clock. While the firmware upgrade is taking place, the 10 MHz output is still being produced, but is slowly drifting. The GPS module is still producing 1 PPS pulses, and the FPGA still holds the last state variables. After the firmware has been upgraded, and as power remains applied to the base-station controller, the running firmware restarts the disciplined clock control loop using the state variables stored in the FPGA RAM. This provides a perfect restart point for the process which wilt declare a lock within seconds instead of the power-up 800 s. It should be noted that the specific structure in the FPGA designed for repositioning the measurement point on the 10 MHz reference output phase has also been used.

This technique also covers the upgrade of the FPGA configuration and after having read-back the disciplined clock states from the FPGA, the base-station controller reconfigures it completely, and re-initializes it with the saved settings. The TCVCXO bias input remains unaffected. The FPGA however gets reconfigured because the DAC keeps the last programmed value in its own internal register.

Referring to FIGS. 3-5 in greater detail, the raw phase comparator value (pc(k)) is read and validated to ensure that it is within a prescribed range for the phase comparator (51). As such the raw phase comparator value is compared to a set upper limit, e.g., 4812. If raw phase comparator value is larger than the set upper limit, an error or fault is identified and logged. An error value is set (x(k)) by taking the difference between the raw phase comparator value and the set upper limit. The raw phase comparator value is also clipped or topped to the set upper limit by setting the value to be equal to the set upper limit. The instantaneous frequency offset is evaluated utilizing the raw phase comparator value (52). The value of the frequency offset (fo(k)) is expressed in parts per million (PPM) with respect to the 10 MHz clock signal.

In one embodiment, the difference between the raw phase comparator value and a previous sample of the raw phase comparator value (pc(k−1)) is compared to a set compare point, e.g., −1200. If the difference is below the set compare point, the frequency offset value is set to the previous sample raw phase comparator value minus the current raw phase comparator value minus a set limit point, e.g., 4800. If the difference exceeds a set compare point, e.g., 1200, the frequency offset value is set to the previous sample raw phase comparator value plus the current raw phase comparator value plus the set limit point, e.g., 4800. If the difference does not fall into either of these conditions, the frequency offset value is set to the previous raw phase comparator value minus the current raw phase comparator value. In this illustrated embodiment, the frequency offset in PPM at sample k=fo(k)/48. The frequency offset value however is sensitive to phase noise and thus may not be suitable for precise frequency measurement to determine if a valid 10 MHz signal is produced, e.g., a precise 10 MHz signal to 0.1 PPM with respect to the GPS UTC. Accordingly, a frequency offset smoothed variable (fos(k)) is introduced. The frequency offset smoothed variable is a scaled and low pass filtered version of the instantaneous frequency offset value. In this embodiment, the frequency offset smooth variable is defined as follows:

fos(k)=φfos(k−1)+(1−φ)(fo(k)/48)

Due to the 1 PPS jitter as noted above, the measurement of instantaneous frequency offset can be difficult to perform with precision. The instantaneous frequency offset is checked to determine if it is sufficiently small to ensure capture (59). In this embodiment, the absolute value of the frequency offset is compared to a set frequency offset limit expressed in PPM (48×folimit). If the instantaneous frequency offset is low (sufficiently small), the process proceeds to determine if a lock condition is present (53). Otherwise, the process proceeds to a brute forced-convergence process (60 and 61). In particular, conditions or variable flags are reset to identify the locked and the 10 MHz signal being valid conditions as false. The hold over timer is also zeroed.

According to the sign of the frequency offset calculated, the value accumulated in the integrator I(k) 32 is corrected directly. The correction utilizes an ISTEP parameter. The ISTEP parameter is provided in PPM and thus is multiplied by a KSTEP value to convert the PPM offset to an equivalent DAC voltage change with Ka=1 and Kf=50 Hz/V. The value to output to the DAC is thus prepared (57) (FIG. 3). The value is calculated as I(k)+P(k) and is saturated (DACS(k)) before being offset (DACS(k)+DAC_OFFSET) and sent to the DAC (write DAC(k) to FPGA DAC register). The bipolar saturation value is DACS_WINDOW parameter.

If a lock condition is present, a dynamically variable width pass-window filter is utilized (54). The filter clips large error signal values (x(k)). The value at which the error is clipped is the result of a low pass filter being applied on the absolute value of the error signal value, but is not set lower than a set window lower limit (windowmin). The filter response is defined by β.

Subsequent to the pass-window filter and the setting of the error signal for consistency (58), error filtering, feed-forward term calculation and integral term calculation are applied (55). Loop status is evaluated and updated (56). In particular, referring to FIG. 4, a lock condition is determined (71), e.g., the amplitude of the raw frequency offset is examined. If a lock condition is present, non-linear filtering is applied if the frequency offset is rising (72) as evaluated by ABS{(1−η)[fo(k)−forect(k−1)]}>48×forect.step.max, where forect.step.max is the maximum slew rate of the rectified frequency offset (forect(k)) and η is a low pass filter parameter. If the frequency offset is decaying and a lock condition is not present, a linear filter is applied (73) as provided by forect(k)=λforect(k−1)+(1−λ) ABS(fo(k)) with λ is a low pass filter parameter.

The lock condition is then examined to implement hysteresis (74,75). In this embodiment, the absolute value of the rectified frequency offset is compared to a set lockin threshold and to a set lockout threshold. If the absolute value is below or equal to the lock in threshold, the absolute value of the error value is checked (76). If less than a set error limit (e.g., 49), a LOCKED and a 10 MHz_VALID signal are declared true along with the hold over timer being set. The temperature is also saved at which the disciplined clock has been declared locked. The temperature is saved for every lock event for each re-evaluation. If the error value exceeds the lockout threshold, the LOCKED and 10 MHz_VALID signals are declared false and the hold over timer zeroed. The rectified frequency offset is set equal to the lock out threshold limit (48×lockout.threshold) if the absolute value of the rectified frequency offset is less than the lockout threshold limit. If the absolute value of the rectified frequency offset is greater than the set lock out threshold, a lock and a valid 10 MHz signal are declared false and the hold over timer zeroed.

The lock condition is examined again (78). If a lock is present, the process continues the application of the DAC voltage (57) (FIG. 3). Otherwise, the disciplined clock TCXO is examined (79) to determine if the clock is becoming uncontrollable due to the TCXO being old. ABS{ka[I(k)+P(k)]}>TCXO.OLD.LIM is used to examine the clock where TCXO.OLD.LIM is a set threshold limit that indicates the clock is uncontrollable. If clock is uncontrollable, the clock is declared old or unusable (80). Otherwise, the process continues to the application of the DAC voltage (57) (FIG. 3).

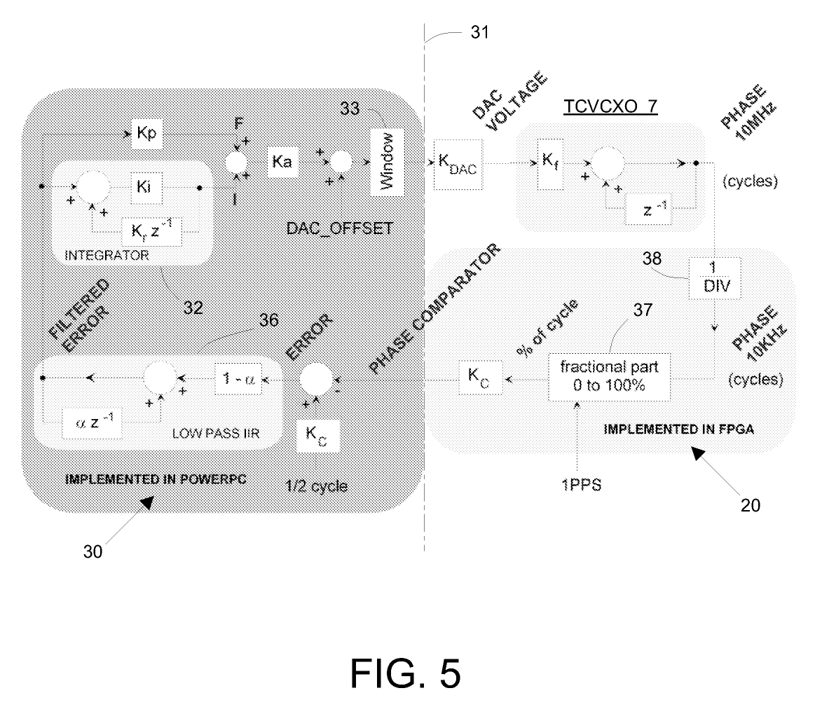

FIG.5 illustrates a conceptual phase control model of the clock control system/process and abstractly delineates (via line 31) portions implemented on a PowerPC (BSC controller) 30 and portions implemented in the FPGA 20 along with associated circuitry (e.g., TCVCXO 7). As shown, a phase comparator implemented in the FPGA compares the phase between the 10 MHz signal to the 1 PPS signal. Divider 38 lowers the frequency of the relatively high frequency output signal (10 MHz) for comparison to the relatively low frequency (1 Hz) 1 PPS signal. Fractional part 37 converts the phase value of the 10 KHz signal to a percentage or integer from zero to 100 where 50 represents π and 100 represents 2π. Applying the percentage to the controller gain (K_{c}) and utilizing the middle portion of a cycle (e.g., ½ cycles), an error signal is generated that is filtered by the low pass IIR 36. The one sample delay feedback is represented by operator z⁻¹ and α is the filter pole multiplied by −1. The outputs of the feed forward path (Proportional gain Kₚ) and the Integral path (32) are summed, scaled by Kₐ, offset and subject to window clipping 33 resulting in the output (K_{DAC}) to the DAC 5 to adjust the 10 MHz output clock signal as needed to lock to the 1 PPS reference signal.

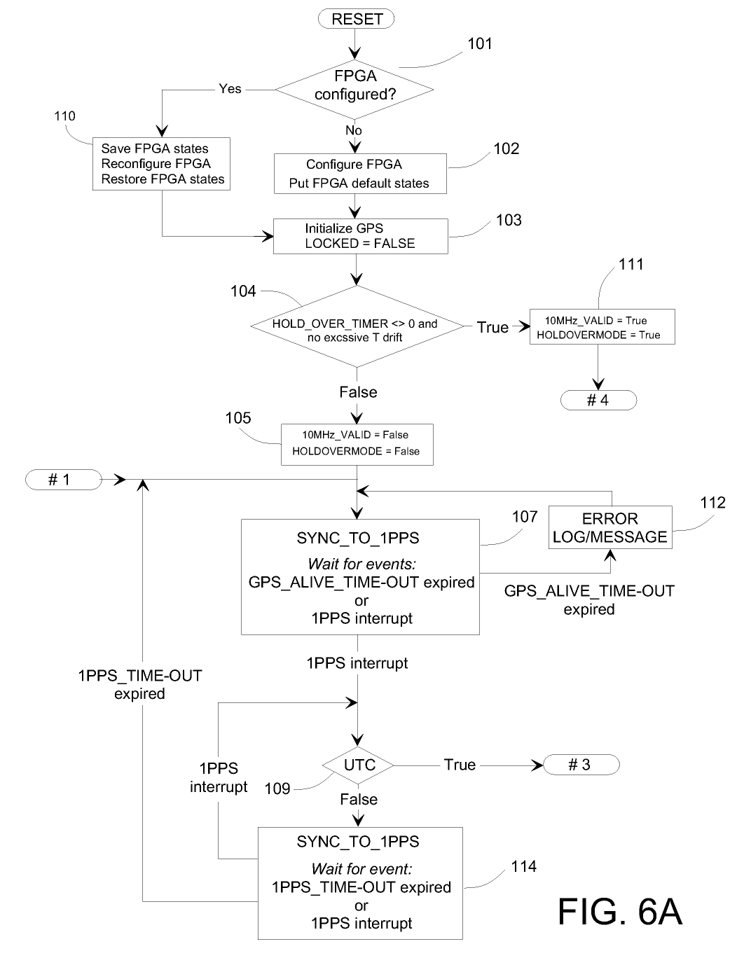

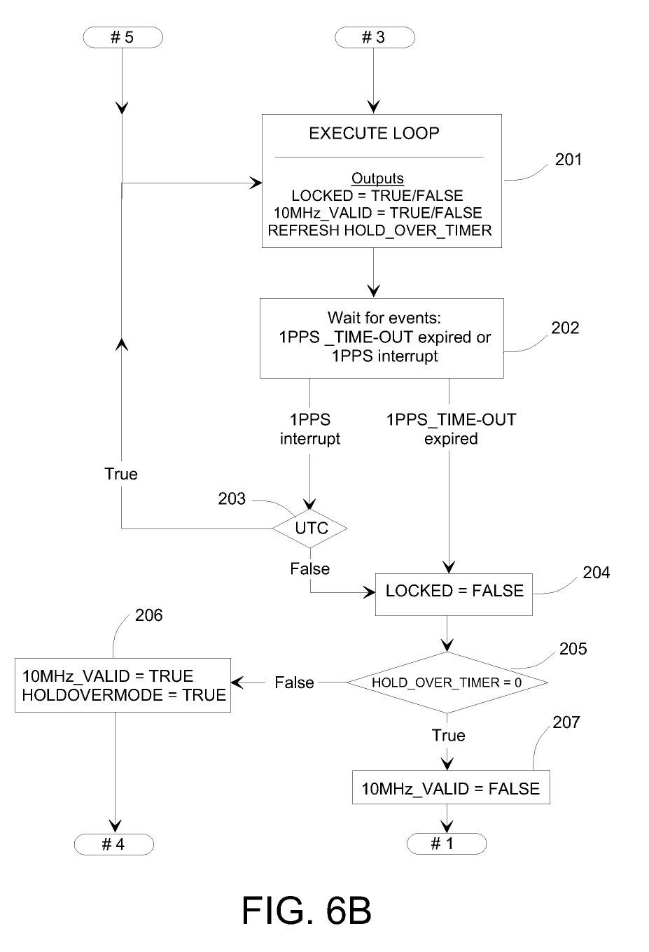

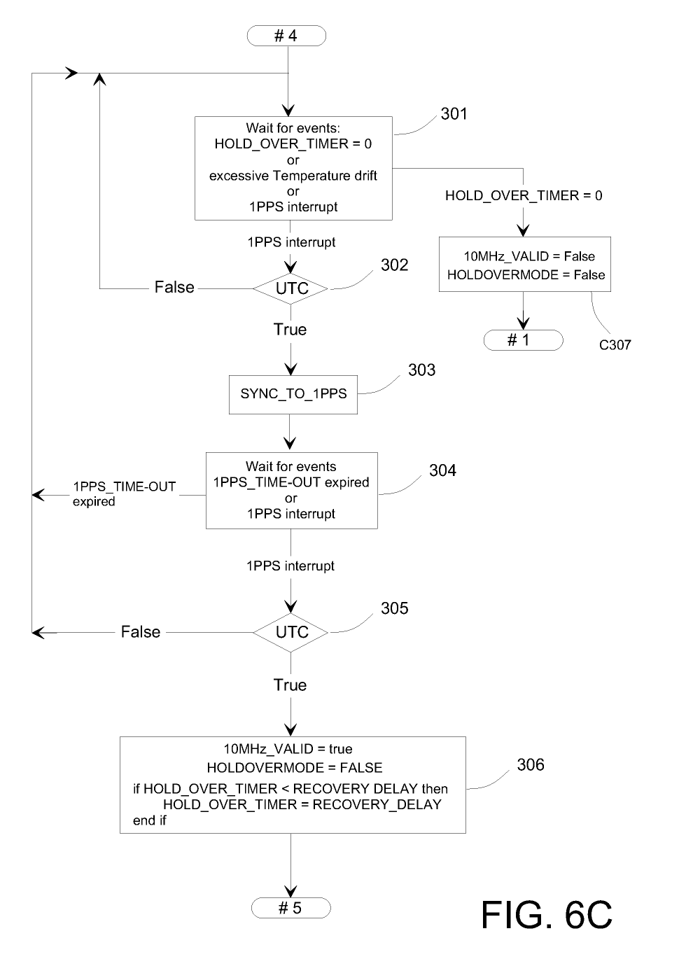

FIGS. 6A-C illustrate additional details regarding the control process of the clock control system as noted above. In FIG. 6A, the FPGA is being reset. Determination of the configuration is examined (101). The determination of the configuration of the FPGA in one embodiment is checked by examining and verifying the contents of some control registers, and the CRC (cyclic redundancy check) associated with the whole parameter and state space (FPGA internal RAM pages). If the FPGA is already configured, the FPGA states are saved and the FPGA shutdown and then configured and the saved states restored (110). Otherwise, the FPGA is configured and default states loaded into the FPGA (102). The GPS module is initialized (103). The unlocked condition is also declared. The GPS module in one embodiment is initialized to output a 1 PPS signal even if the GPS receiving satellite receiver fails. The hold over timer is examined (104) via the FPGA registers. The temperature drift is also examined (104). The temperature drift is the absolute value of the difference between the temperature indicated or stored in memory (e.g., read from the FPGA registers at the last time a lock condition occurred) and the current temperature. If the hold over timer is not zero and the temperature drift is not excessive, the 10 MHz signal is declared valid and the hold over mode is set true (111). Generally, hold over mode is set when the hold over time is not zero, lock is false and the temperature drift is not excessive. When hold over mode is set, the 10 MHz signal is valid. With hold over mode set, the process waits for the hold over timer to reach zero, the temperature drift to be excessive or a reference pulse (1 PPS) interrupt (301) (FIG. 6C).

If hold over mode is not set and the 10 MHz signal not valid (105), the process waits for a reference pulse interrupt or a GPS time-out expiring (107). If the GPS time out expired event occurs an error message is provided and/or logged (112) and the process continues back to wait for reference pulse interrupt or another time out event (107). If a reference pulse interrupt occurs, the UTC is checked (109). In one embodiment, the GPS module status is read to verify that a 1 PPS UTC is being produced instead of a 1 PPS RTC. If a UTC is not being produced, the process waits for a 1 PPS time out expiring or a 1 PPS interrupt (114). If the 1 PPS time out expired event occurs, the GPS time out or a 1 PPS interrupt is examined (107). If a 1 PPS interrupt occurs, the UTC is again checked (109). In one embodiment, the rechecking of the UTC when a UTC is not being produced is limited to, e.g., fifteen minutes for a one second inaccurate GPS 1 PPS RTC. With the UTC being produced, the process continues to the control process (201) (FIGS. 6B and 3).

In FIG. 6B, the control process provided in FIG. 3 is initiated (201). As a result of the control process, the locked and a valid 10 MHz signal are determined and the hold over timer set. The process then waits for a reference pulse event (202). If there is a 1 PPS interrupt, the process repeats back initiating the control process (201) if the UTC is present (203). If a 1 PPS time out expired occurs or a UTC is not present then an unlocked or false locked condition is declared (204). The hold over timer is also compared to zero to determine the validity of the 10 MHz signal. If zero, the 10 MHz signal is not valid (207). Otherwise, the 10 MHz signal is declared valid and hold over mode is set (206).

With the hold over mode set the process continues as shown in FIG. 6C. The process waits for the hold over timer to reach zero, the temperature drift to be excessive (e.g., absolute value of the difference between the temperature indicated or stored and the current temperature or a reference pulse (1 PPS) interrupt occurring (301). If the hold over time reaches zero, the 10 MHz signal is declared not valid and the hold over mode set to false (307). If a 1 PPS interrupt occurs, the UTC is checked (302) and if present, the phase accumulation of the feedback 10 KHz signal in the FPGA is cleared (303). The process continues and waits for a 1 PPS time out expired event or a 1 PPS interrupt event (304). If a 1 PPS interrupt occurs, the UTC is checked (305). If the UTC is present, the 10 MHz signal is reassessed (306). With the clock being not locked, the hold over mode is declared true and extended for a specific period of time. As such, the hold over timer is set to at least equal to a minimum delay (recovery_delay). Upon recovery from the holdover period specific variables are cleared (pc(k−1), wpos(k=1), xj(k−1), y(k−1), forect(k−1)) and others retrieved from memory (fos(k−1) and I(k−1). If the UTC is not present (302 or 305) or a 1 PPS time out expired event occurs (304), the process continues back to wait for other events to occur (301).

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

1. A global positioning system based disciplined reference clock circuitry comprising:
a global positioning system receiver generating a reference pulse;
a digital to analog converter supplying a control voltage; and
an oscillator locked to the reference pulse from global positioning module and controlled via the control voltage of the digital to analog converter to generate a clock signal.

2. The circuitry of claim 1 wherein the oscillator is a temperature compensated voltage controlled crystal oscillator and the clock signal is a frequency accurate 10 MHz clock signal.

3. The circuitry of claim 1 further comprising a phase comparator measuring a delay between the reference pulse and the generated clock signal.

4. The circuitry of claim 3 further comprising a processor commanding the digital to analog converter to supply a control voltage based on the measured delay.

5. The circuitry of claim 3 further comprising a low pass filter filtering the reference pulse.

6. The circuitry of claim 5 wherein the low pass filter reduces jitter on the reference pulse by applying a width adaptive window.

7. The circuitry of claim 3 wherein the reference pulse is a 1 pulse per second universal time coordinated signal.

8. The circuitry of claim 3 further comprising a count timer activated by the processor when the reference pulse is lost.

9. The circuitry of claim 8 wherein the processor repositions a measurement point of the clock signal relative to the reference pulse when the reference pulse is restored.

10. The circuitry of claim 3 further comprising memory coupled to the processor and storing state variables of the disciplined clock circuitry.

11. A method of generating a disciplined clock from a global positioning system based disciplined reference clock circuitry, the method comprising:
receiving a reference pulse from a global positioning system receiver;
generating a clock signal based on the received reference pulse;
estimating an instantaneous frequency offset between the reference pulse and the clock signal; and
applying a control voltage to an oscillator based on the estimated instantaneous frequency offset compared an absolute value of the frequency offset to adjust a frequency of the clock signal.

12. The method of claim 11 further comprising rectifying the estimated instantaneous frequency offset.

13. The method of claim 12 further comprising filtering the rectified frequency offset.

14. The method of claim 13 further comprising applying a control voltage to the oscillator based on the filtered and rectified frequency offset compared to a set limit.

15. The method of claim 11 further comprising clipping jitter on the reference pulse using a width adaptive window.

16. The method of claim 15 further comprising widening the window when clipping occurs by increasing upper and lower limits of the window.

17. The method of claim 16 further comprising narrowing the window when no clipping occurs by reducing upper and lower limits of the window.

18. The method of claim 17 wherein the upper and lower limits of the window are based on a feedback ratio of a low pass filter.

19. The method of claim 18 further comprising storing all clock state variables in memory.

20. The method of claim 11 further comprising adjusting a measuring point between the reference pulse and the clock signal for estimating the frequency offset.
